(19) United States
(12) Patent Application Publication
(10) Pub. No.: US 2026/0093968 A1
(43) Pub. Date: Apr. 2, 2026

(54) MEMORY CIRCUITS AND METHODS FOR ENCODER/DECODER DUAL MODE FOR COMPUTE-IN-MEMORY

(71) Applicant: Taiwan Semiconductor Manufacturing Company, Ltd., Hsinchu (TW)

(72) Inventors: Je-Min Hung, Hsinchu City (TW); Haruki Mori, Hsinchu City (TW); Hidehiro Fujiwara, Hsinchu City (TW)

(73) Assignee: Taiwan Semiconductor Manufacturing Company, Ltd., Hsinchu (TW)

(21) Appl. No.: 18/990,207

(22) Filed: Dec. 20, 2024

Related U.S. Application Data
(60) Provisional application No. 63/702,329, filed on Oct. 2, 2024.

(51) Int. Cl. G06N 3/063; G06N 3/0455

(52) U.S. Cl. CPC G06N 3/063; G06N 3/0455

(57) ABSTRACT

An integrated circuit may comprise a plurality of compute-in-memory (CIM) circuits physically formed on a substrate. Each of the plurality of CIM circuits may comprise: an input circuit configured to receive a plurality of first data elements; a memory array coupled to the input circuit and configured to store the plurality of first data elements; a data multiplexer configured to output the plurality of first data elements through a first data path or through a second data path; and a plurality of computing cells coupled to the data multiplexer and configured to perform multiply-accumulate (MAC) operations on the plurality of first data elements and a plurality of second data elements.

### CROSS-REFERENCE TO RELATED APPLICATION

This application claims priority to and the benefit of U.S. Provisional Application No. 63/702,329, filed Oct. 2, 2024, entitled “Encoder/Decoder Dual Mode CIM Macro,” which is incorporated herein by reference in its entirety for all purposes.

### BACKGROUND

Memory devices are integral components of electronic systems, storing data in a manner that allows for rapid access and modification. Traditionally, memory devices have been designed to store binary information in the form of “0”s and “1”s across a vast array of memory cells. These cells, due to manufacturing variances and design constraints, often exhibit unbalanced physical structures, leading to disparities in their electrical characteristics. Compute-in-memory (CIM) technology integrates processing capabilities directly within memory arrays, enabling faster data computation.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a block diagram of a compute-in-memory (CIM) based accelerator, in accordance with some embodiments of the present disclosure.

FIG. 2 illustrates a detailed schematic diagram of a compute-in-memory (CIM) circuit of FIG. 1, in accordance with some embodiments of the present disclosure.

FIG. 3 illustrates a detailed schematic diagram of a compute-in-memory (CIM) circuit of FIG. 1, in accordance with some embodiments of the present disclosure.

FIG. 4 illustrates a detailed schematic diagram of a compute-in-memory (CIM) circuit of FIG. 1, in accordance with some embodiments of the present disclosure.

FIG. 5 illustrates a block diagram of a compute-in-memory (CIM) based accelerator, in accordance with some embodiments of the present disclosure.

FIG. 6 illustrates a detailed schematic diagram of a compute-in-memory (CIM) circuit of FIG. 5, in accordance with some embodiments of the present disclosure.

FIG. 7 illustrates a detailed schematic diagram of a compute-in-memory (CIM) circuit of FIG. 5, in accordance with some embodiments of the present disclosure.

FIG. 8 is a flowchart of an example method for operating a compute-in-memory (CIM) circuit, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In a compute-in-memory (CIM) architecture, the CIM macro for an encoder structure can be equipped with a memory array (e.g., a latch array), which facilitates weight reuse—a feature for efficient processing in encoder tasks. In contrast, the CIM macro designed for a decoder structure does not necessitate a memory array (e.g., a latch array) for weight reuse, addressing a different set of operational efficiencies and constraints. A conventional CIM macro can support only either an encoder structure or a decoder structure. In the proposed compute-in-memory (CIM) architecture of the present application, the CIM circuit is designed to support both encoder and decoder functions of a transformer model, which inherently includes separate encoder and decoder structures. The present application allows the CIM architecture to effectively accommodate the distinct functionalities of both the encoder and decoder, overcoming the limitations of conventional CIM macros which typically support only one of these structures. This dual-capability design enhances overall processing efficiency and adaptability in handling the diverse computational demands of transformer models.

The transformer architecture/model may be divided into an encoder component and a decoder component. The input to the encoder component may include the summation of the input embedding and the positional encoding of the input tokens. Positional encoding is required since, unlike sequential architectures, such as recurrent neural networks where the input tokens are sequentially inserted and hence retain the order of the input tokens, in the transformer there is no notion of the order of the words. The architecture of the encoder layer may include two sub-layers. The first sub-layer may include a multi-head attention component, followed by an add and normalization component. The second sub-layer may include a feed forward neural network component, followed by an add and normalization component. A multi-head attention component may include multiple instances of the scaled dot-product attention, where each instance has its own weights to improve the generalization of the model. The output matrix of each instance {zo, . . . zn} is concatenated and multiplied by a weight matrix Wo, resulting in an output matrix.

The architecture of the decoder layer, in the transformer architecture, may include three sub-layers. The first sub-layer includes a masked multi-head attention component, followed by an add and normalization component. The second sub-layer includes a multi-head attention (Encoder-Decoder) component, followed by an add and normalization component. The third sub-layer includes a feed forward network component, followed by an add and normalization component. The Encoder-Decoder attention component is similar to the multi-head attention component, however the query vector Q is from the previous sub-layer of the decoder layer, and the key vectors K and value vectors V are retrieved from the output of the final encoder layer. The masked multi-head attention component is a multi-head attention component with a modification such that the self-attention layer is only allowed to attend to earlier positions of the input tokens. The output of the decoder layer may be connected to a linear layer, followed by the SoftMax computation to generate the probabilities of the output vocabulary, representing the predicted tokens. The input to the decoder component may include the token embeddings of the output tokens and the positional encoding.

A core component of the transformer architecture is the attention component. A transformer may have three types of attention mechanisms: Encoder Self-Attention, Decoder Self-Attention and Encoder-Decoder Attention. The input of the Encoder Self-Attention is the source input tokens of the Transformer, or the output of the previous encoder layer. The Encoder Self-Attention component does not have masking and each token has a global dependency with the other input tokens. The Decoder Self-Attention component uses the output tokens of the transformer as the input tokens, or the output of the previous decoder layer. In a Decoder Self-Attention, the input tokens are dependent on the previous input tokens. In the Encoder-Decoder Attention component, the queries are retrieved from the previous component of the decoder layer and the keys and values are retrieved from the output of the encoder. In some embodiments, the encoder reads and processes the input data simultaneously using self-attention and position-wise feed-forward networks. The encoder converts the input into a set of attention vectors that represent different aspects of the input. In some embodiments, the decoder generates the output sequence step-by-step. The encoder uses self-attention to consider other words in the output so far and encoder-decoder attention to focus on relevant parts of the input.

The compute-in-memory (CIM) circuits presented in the present application provides significant enhancements in hardware efficiency and area utilization for neural network accelerators, such as tensor processing units (TPUs), graphics processing units (GPUs), neural network processing units (NPUs). In some embodiments, the present application addresses the inefficiencies found in traditional transformer-based models (e.g., ChatGPT), which utilize dedicated CIM hardware for both the encoder and decoder structures. These models face utilization challenges, as only one set of hardware (either encoder or decoder) is active at a time, leading to significant idle periods. In the conventional setup, the CIM encoder (e.g., memory intensive), which is not computation-intensive and requires a memory array for data reuse, remains underutilized when the compute-intensive CIM decoder (e.g., computing intensive), which does not require a memory array for data reuse, is in operation, and vice versa.

The proposed En/Decoder dual-mode CIM architecture dramatically improves the above situation by enabling a single CIM macro to switch dynamically between encoder and decoder functions (by incorporating at least one data multiplexer), thereby maintaining high utilization across both processing tasks. This dual functionality not only leads to smaller area overhead, but also enhances the operational efficiency of the system. By allowing the CIM circuit to support both encoder and decoder functions, this flexible approach addresses the resource underutilization issues in conventional transformer models, paving the way for more compact and efficient neural network accelerators.

The present disclosure provides various embodiments of an integrated circuit that address such underutilization issues for encoders and decoders. For example, the integrated circuit, as disclosed herein, comprises a plurality of compute-in-memory (CIM) circuits physically formed on a substrate. Each of the plurality of CIM circuits may comprise: an input circuit, a memory array, a data multiplexer, and a plurality of computing cells. The input circuit can be configured to receive a plurality of first data elements. The memory array can be coupled to the input circuit and can be configured to store the plurality of first data elements. The data multiplexer can be configured to output the plurality of first data elements through a first data path or through a second data path. The plurality of computing cells can be coupled to the data multiplexer and can be configured to perform multiply-accumulate (MAC) operations on the plurality of first data elements and a plurality of second data elements.

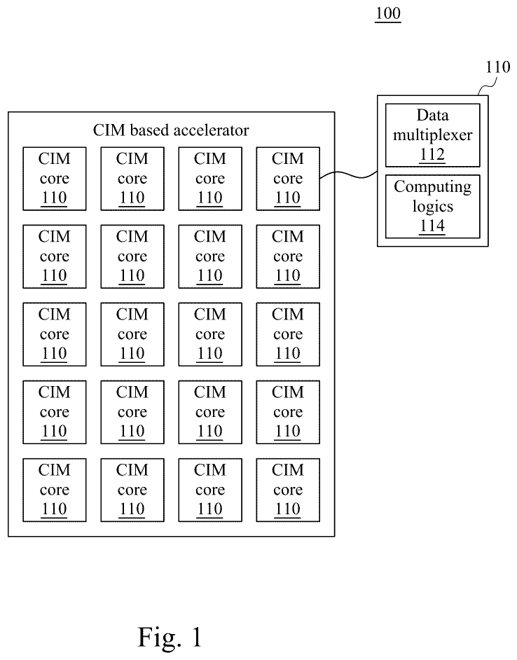

FIG. 1 illustrates a block diagram of a compute-in-memory (CIM) based accelerator, in accordance with some embodiments of the present disclosure. It is understood that FIG. 1 has been simplified for a better understanding of the concepts of the present disclosure. The CIM based accelerator 100 may include a plurality of compute-in-memory (CIM) circuits 110 (e.g., CIM cores). Each of the plurality of CIM circuits may comprise a data multiplexer 112 and a plurality of computing cells 114. In some embodiments, an enable signal can be received by the plurality of CIM circuits 110. In certain embodiments, a plural number of enable signals can be received by the plurality of CIM circuits 110, respectively. In some embodiments, the plurality of CIM circuits can be physically formed on a substrate.

In some embodiments, the data multiplexer 112 may receive an enable signal. The data multiplexer 112 can be configured to output a plurality of first data elements through a first data path or through a second data path according to the enable signal. In response to the enable signal being configured with a first logic state (e.g., 1, encoder mode), the data multiplexer 112 may select the first data path. In response to the enable signal being configured with a second logic state (e.g., 0, decoder mode), the data multiplexer 112 may select the second data path. In some embodiments, the first data path may operatively extend from an input circuit, through a memory array and the data multiplexer 112, and to the plurality of computing cells 114. In some embodiments, the second data path may operatively extend from an input circuit, through the data multiplexer 112, and to the plurality of computing cells 114.

By processing through the first data path, the CIM circuit 110 can function as an encoder (e.g., encoder mode). The encoder may include a multi-head attention component and a feed forward neural network component. The multi-head attention component is configured to perform self-attention processes in parallel using different weight matrices, allowing the model to capture various types of relationships in the data simultaneously. The feed forward neural network component is configured to further refine the attention-processed output. Each position in the input sequence undergoes the same neural network process independently. There is no need for masking in the self-attention layers of the encoder because all inputs are available at the time of processing.

By processing through the second data path, the CIM circuit 110 can function as a decoder (e.g., decoder mode). The decoder may include a masked multi-head attention component, a multi-head attention component, and a feed forward network component. The masked multi-head attention component can be configured to selectively prevent certain positions in an input sequence from influencing output positions during attention calculations. The multi-head attention component can be configured to process multiple attention mechanisms in parallel, each applying attention to different representation subspaces of the input sequence. The feed forward network component can be structured to apply the same neural network configuration across all positions in a sequence independently. Both the encoder and decoder layers use layer normalization and residual connections around each sub-layer (self-attention, feed-forward networks, and in the decoder, encoder-decoder attention) to facilitate training and improve the flow of gradients through the network.

Within a neural network, a node attributes a numerical value, termed a “weight,” to its connections. When activated, a node can multiply incoming data by this weight and sum up the products from all its connections, resulting in a single numeric output. In a deep learning system, a neural network model is stored in memory and computational logic in a processor performs multiply-accumulate (MAC) computations on the parameters (e.g., weights) stored in the memory. In some embodiments, the weights can be stored in a plurality of memory cells within a memory array.

In some embodiments, the plurality of computing cells 114 can be coupled to the data multiplexer 112. In some embodiments, the plurality of computing cells 114 can be configured to receive multiple inputs (e.g., first data elements, second data elements). The plurality of computing cells 114 can be configured to perform multiply-accumulate (MAC) operations on the plurality of first data elements and a plurality of second data elements. In some embodiments, the first data elements may include a plurality of weight data elements. The second data elements may include a plurality of input data elements. In certain embodiments, the first data elements may include a plurality of input data elements. The second data elements may include a plurality of weight data elements.

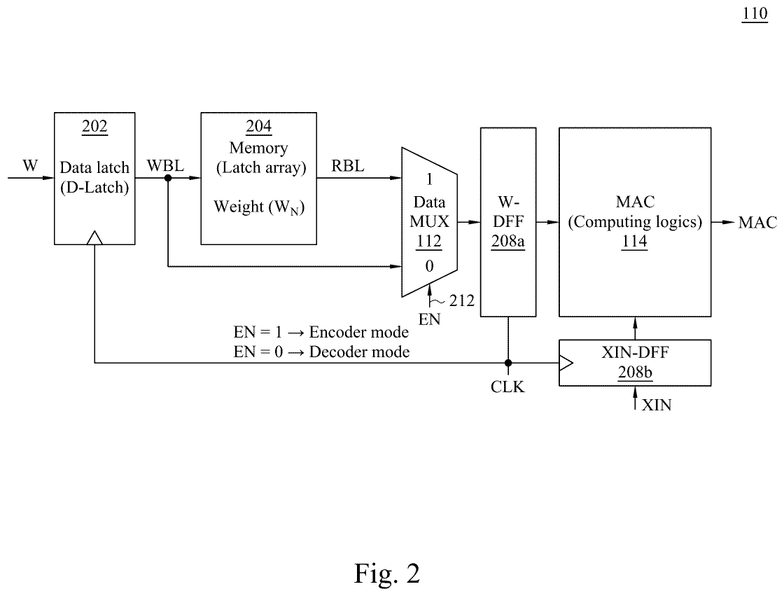

FIG. 2 illustrates a detailed schematic diagram of a compute-in-memory (CIM) circuit 110 of FIG. 1, in accordance with some embodiments of the present disclosure. It is understood that FIG. 2 has been simplified for a better understanding of the concepts of the present disclosure. The CIM circuit 110 (e.g., CIM core) may include an input circuit 202, a memory array 204, a data multiplexer 112, and a plurality of computing cells 114.

In some embodiments, the input circuit 202 can be configured to receive a plurality of first data elements. In some embodiments, the input circuit 202 can a data latch, which facilitates weight reuse. The input circuit 202 may have a data input (e.g., W) and a clock input (e.g., CLK). In some embodiments, the input circuit 202 captures the value on the data input at a specific part of the clock cycle and holds this value until the next clock pulse. In some embodiments, the first data elements may include a plurality of weight data elements. In certain embodiments, the first data elements may include a plurality of input data elements.

In some embodiments, the memory array 204 can be coupled to the input circuit 202. The memory array 204 can be configured to store the plurality of first data elements. In some embodiments, the memory array 204 may include a plurality of memory cells. Each of the plurality of memory cells can incorporate various types of non-volatile or volatile memory technologies, including but not limited to static random-access memory (SRAM), dynamic random access memory (DRAM), resistive random-access memory (ReRAM), magnetoresistive random-access memory (MRAM), and phase-change random access memory (PCRAM). One or more peripheral circuits (not shown) may be located at one or more regions peripheral to, or within, the memory array 204. The memory cells and the periphery circuits may be coupled by word lines and/or complementary bit lines BL and BLB, and data can read from and written to the memory bit cells via the complementary bit lines BL and BLB. Different voltage combinations applied to the word lines and bit lines may define a read, erase or write (program) operation on the memory bit cells.

In some embodiments, the data multiplexer 112 may receive an enable signal 212. In some embodiments, the enable signal 212 can be configured with a first logic state (e.g., 1) or a second logic state (e.g., 0). The data multiplexer 112 can be configured to output a plurality of first data elements through a first data path or through a second data path according to the enable signal. In response to the enable signal being configured with a first logic state (e.g., 1, encoder mode), the data multiplexer 112 may select the first data path. In response to the enable signal being configured with a second logic state (e.g., 0, decoder mode), the data multiplexer 112 may select the second data path. In some embodiments, the first data path may operatively extend from the input circuit 202, through the memory array 204 and the data multiplexer 112, and to the plurality of computing cells 114. In some embodiments, the second data path may operatively extend from the input circuit 202, through the data multiplexer 112, and to the plurality of computing cells 114.

By processing through the first data path, the CIM circuit 110 can function as an encoder (e.g., encoder mode). The encoder may include a multi-head attention component and a feed forward neural network component. The multi-head attention component is configured to perform self-attention processes in parallel using different weight matrices, allowing the model to capture various types of relationships in the data simultaneously. The feed forward neural network component is configured to further refine the attention-processed output. Each position in the input sequence undergoes the same neural network process independently. There is no need for masking in the self-attention layers of the encoder because all inputs are available at the time of processing.

By processing through the second data path, the CIM circuit 110 can function as a decoder (e.g., decoder mode). The decoder may include a masked multi-head attention component, a multi-head attention component, and a feed forward network component. The masked multi-head attention component can be configured to selectively prevent certain positions in an input sequence from influencing output positions during attention calculations. The multi-head attention component can be configured to process multiple attention mechanisms in parallel, each applying attention to different representation subspaces of the input sequence. The feed forward network component can be structured to apply the same neural network configuration across all positions in a sequence independently. Both the encoder and decoder layers use layer normalization and residual connections around each sub-layer (self-attention, feed-forward networks, and in the decoder, encoder-decoder attention) to facilitate training and improve the flow of gradients through the network.

In some embodiments, the plurality of computing cells 114 can be coupled to the data multiplexer 112. In some embodiments, the plurality of computing cells 114 can be configured to receive multiple inputs (e.g., first data elements 208a, second data elements 208b). The plurality of computing cells 114 can be configured to perform multiply-accumulate (MAC) operations on the plurality of first data elements 208a and the plurality of second data elements 208b. In some embodiments, the first data elements 208a may include a plurality of weight data elements (e.g., W). The second data elements 208b may include a plurality of input data elements (e.g., Xin). In certain embodiments, the first data elements 208a may include a plurality of input data elements (e.g., Xin). The second data elements 208b may include a plurality of weight data elements (e.g., W).

The present application provides an additional data path to an encoder CIM circuit. The new data path can be engineered to bypass the memory array, thereby enabling the encoder CIM circuit to support decoder functions. This approach introduces minimal area overhead to the overall design in the CIM circuit. Furthermore, the integration of an additional data multiplexer (MUX) along this new data path optimizes the routing of data between encoder and decoder modes. This dual functionality not only maximizes the utility and efficiency of the CIM architecture but also preserves the compactness essential for integrated circuit design.

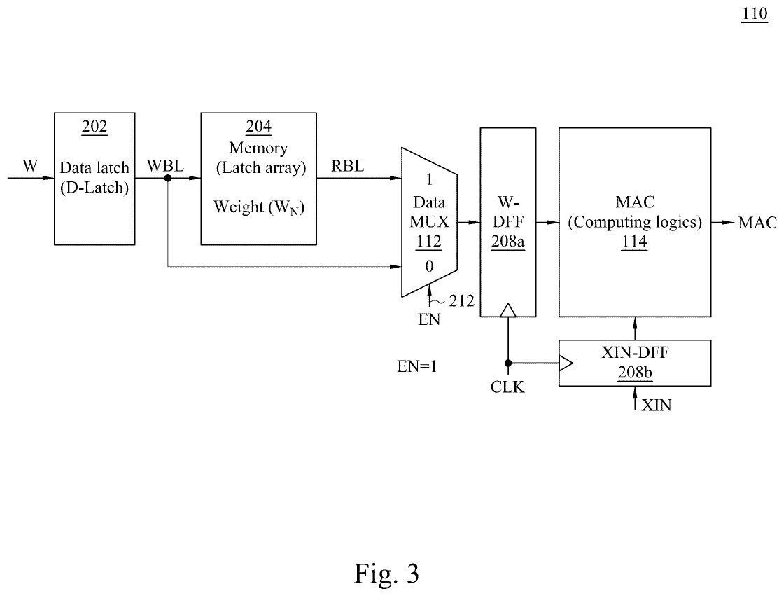

FIG. 3 illustrates a detailed schematic diagram of a compute-in-memory (CIM) circuit 110 of FIG. 1, in accordance with some embodiments of the present disclosure. FIG. 3 illustrates an example first data path in the CIM circuit 110, in accordance with some embodiments of the present disclosure. The CIM circuit 110 of FIG. 3 is substantially similar to the CIM circuit 110 of FIG. 2, except for the enable signal being configured with a first logic state (e.g., EN=1).

In some embodiments, in response to the enable signal being configured with a first logic state (e.g., 1, encoder mode), the data multiplexer 112 may select the first data path. In the encoder mode (EN=1) of the CIM circuit 110, the first data path is designed for efficient processing and computation. Specifically, the data flow begins at the data latch 202, which temporarily holds the input data, ensuring stability before the input data is passed into the memory array 204. The memory array 204 serves as the primary storage site where data is maintained for subsequent computational tasks. Following the memory array 204, data progresses through a weight-D flip-flop (W-DFF) 208a, which synchronizes data timing for the next stage of processing. The final component in the first data path is the plurality of computing cells 114 (e.g., Multiply-Accumulate (MAC) unit), which performs the core computational operations using the data retrieved from the memory array 204.

By processing through the first data path, the CIM circuit 110 can function as an encoder (e.g., encoder mode). The encoder may include a multi-head attention component and a feed forward neural network component. The multi-head attention component is configured to perform self-attention processes in parallel using different weight matrices, allowing the model to capture various types of relationships in the data simultaneously. The feed forward neural network component is configured to further refine the attention-processed output. Each position in the input sequence undergoes the same neural network process independently. There is no need for masking in the self-attention layers of the encoder because all inputs are available at the time of processing.

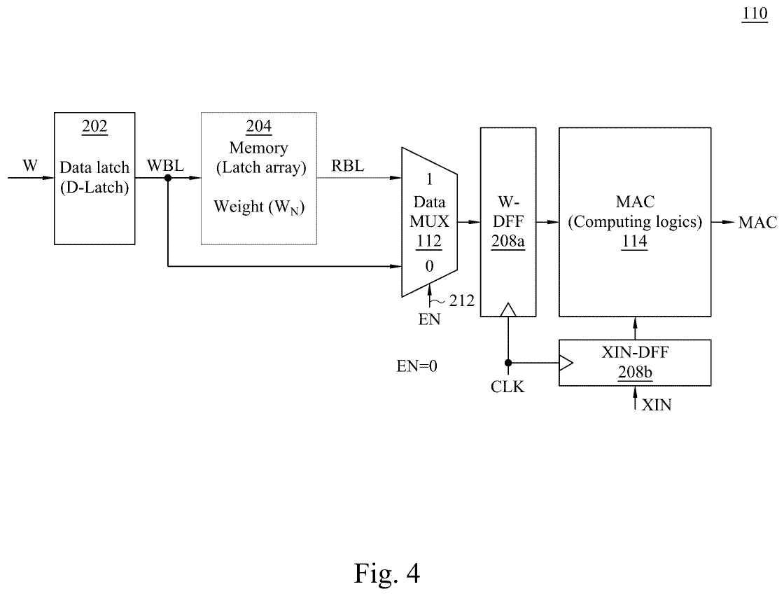

FIG. 4 illustrates a detailed schematic diagram of a compute-in-memory (CIM) circuit of FIG. 1, in accordance with some embodiments of the present disclosure. FIG. 4 illustrates an example second data path in the CIM circuit 110, in accordance with some embodiments of the present disclosure. The CIM circuit 110 of FIG. 4 is substantially similar to the CIM circuit 110 of FIG. 2, except for the enable signal being configured with a second logic state (e.g., EN=0).

In some embodiments, in response to the enable signal being configured with a second logic state (e.g., 0, decoder mode), the data multiplexer 112 may select the second data path. In the decoder mode (EN=0) of the CIM circuit 110, the second data path is streamlined to expedite processing by bypassing the memory array 204. Starting with the data latch 202, input data is temporarily stored and stabilized before moving directly to the weight-D flip-flop (W-DFF) 208a. The W-DFF is for aligning the data timing efficiently as it moves into the final stage, which is the plurality of computing cells 114 (e.g., Multiply-Accumulate (MAC) unit). This configuration eliminates the need for accessing the memory array 204. By directly routing data from the data latch 202 to the MAC 114, the decoder mode optimizes the processing speed and efficiency, making it ideally suited for tasks that require rapid data manipulation (e.g., computing intensive) and output generation without the additional overhead of memory access.

By processing through the second data path, the CIM circuit 110 can function as a decoder (e.g., decoder mode). The decoder may include a masked multi-head attention component, a multi-head attention component, and a feed forward network component. The masked multi-head attention component can be configured to selectively prevent certain positions in an input sequence from influencing output positions during attention calculations. The multi-head attention component can be configured to process multiple attention mechanisms in parallel, each applying attention to different representation subspaces of the input sequence. The feed forward network component can be structured to apply the same neural network configuration across all positions in a sequence independently. Both the encoder and decoder layers use layer normalization and residual connections around each sub-layer (self-attention, feed-forward networks, and in the decoder, encoder-decoder attention) to facilitate training and improve the flow of gradients through the network.

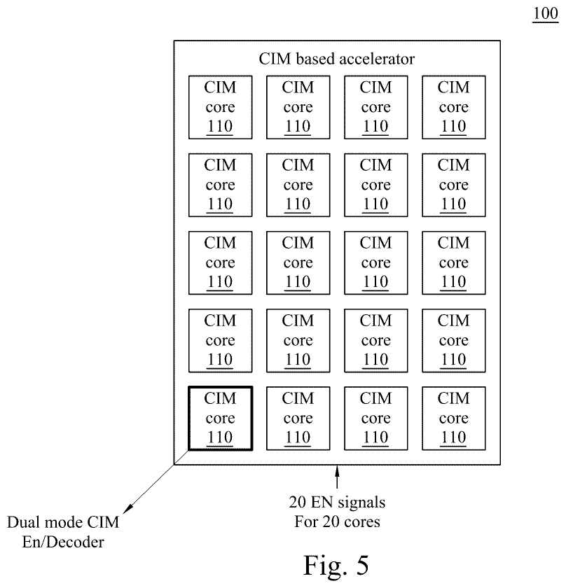

FIG. 5 illustrates a block diagram of a compute-in-memory (CIM) based accelerator 100, in accordance with some embodiments of the present disclosure. The CIM based accelerator 100 may include a plurality of compute-in-memory (CIM) circuits 110 (e.g., CIM cores). In some embodiments, a plural number of enable signals (e.g., ENs) can be received by the plurality of CIM circuits 110, respectively. In some embodiments, the plurality of CIM circuits 110 can be physically formed on a substrate. The CIM based accelerator 100 of FIG. 5 is substantially similar to the CIM based accelerator 100 of FIG. 1, except for the plural number of enable signals being received.

In some embodiments, each of the plurality of CIM circuits 110 may comprise a data multiplexer 112 and a plurality of computing cells 114. Each of the plurality of CIM circuits 110 may receive an enable signal. The data multiplexer 112 can be configured to output a plurality of first data elements through a first data path or through a second data path according to the enable signal (e.g., 1 or 0). In response to the enable signal being configured with a first logic state (e.g., 1, encoder mode), the data multiplexer 112 may select the first data path. In response to the enable signal being configured with a second logic state (e.g., 0, decoder mode), the data multiplexer 112 may select the second data path. In some embodiments, the first data path may operatively extend from the input circuit 202, through the memory array 204 and the data multiplexer 112, and to the plurality of computing cells 114. In some embodiments, the second data path may operatively extend from the input circuit 202, through the data multiplexer 112, and to the plurality of computing cells 114.

In FIG. 5, each CIM circuit 110 is equipped with its own data multiplexer 112 and a set of computing cells 114. These CIM circuits 110 are capable of receiving individual enable signals that dictate operational modes (e.g., encoder mode or decoder mode). The data multiplexer 112 in each circuit plays a pivotal role in directing data flow. The data multiplexer 112 can route a plurality of first data elements either through a first data path or a second data path based on the state of the enable signal—either a “1” or a “0”. This flexible data routing allows each CIM circuit to dynamically switch between different computational tasks or modes, enhancing the accelerator's overall functionality and efficiency. By integrating multiple enable signals corresponding to various cores within the accelerator, the integrated circuit design facilitates precise control and synchronization across the array of CIM circuits, tailored to specific processing demands.

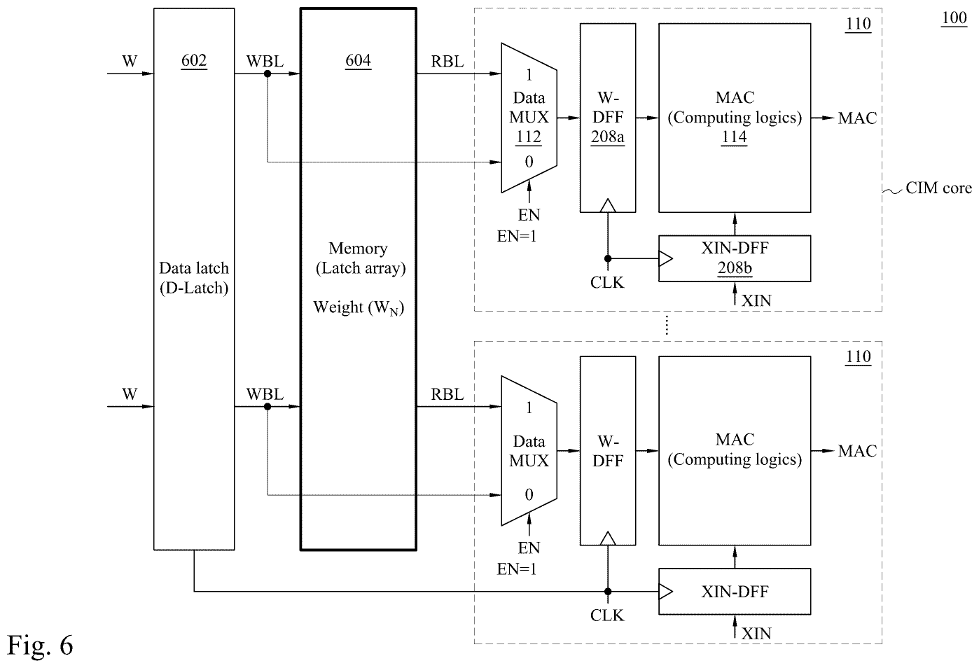

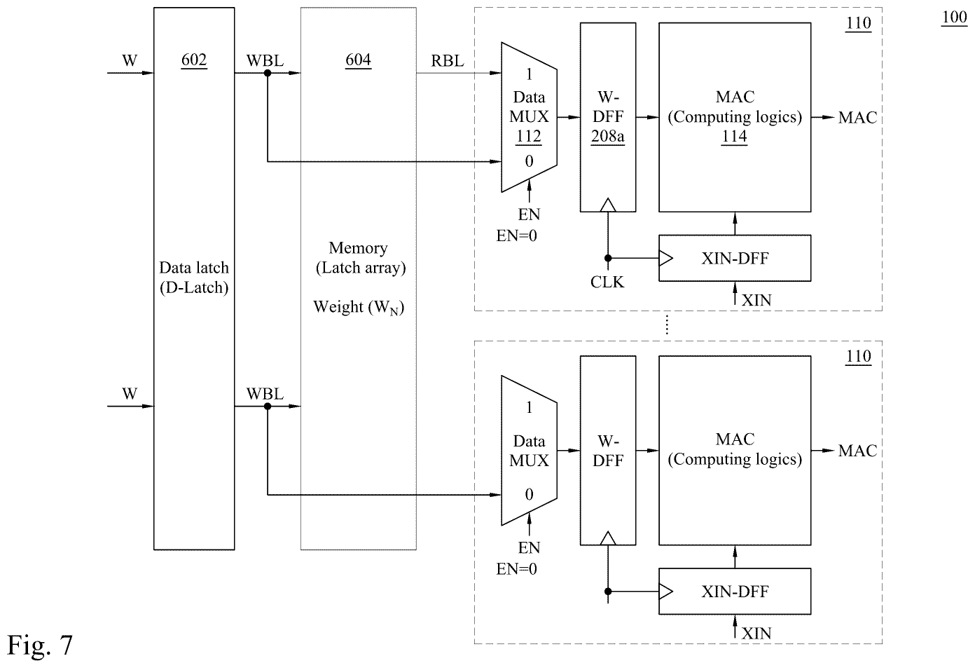

FIG. 6 illustrates a detailed schematic diagram of a compute-in-memory (CIM) circuit of FIG. 5, in accordance with some embodiments of the present disclosure. FIG. 7 illustrates a detailed schematic diagram of a compute-in-memory (CIM) circuit of FIG. 5, in accordance with some embodiments of the present disclosure. The CIM based accelerator 100 may include an input circuit 602, a memory array 604, and a plurality of compute-in-memory (CIM) circuits 110 (e.g., CIM cores). Each of the plurality of CIM circuits may comprise a data multiplexer 112 and a plurality of computing cells 114. In some embodiments, a plural number of enable signals (e.g., ENs) can be received by the plurality of CIM circuits 110, respectively. In some embodiments, the plurality of CIM circuits 110 can be physically formed on a substrate. The CIM based accelerator 100 of FIG. 6 and FIG. 7 is substantially similar to the CIM based accelerator 100 of FIG. 1, with the primary difference being the single memory array that stores weights shared by the CIM cores.

In some embodiments, the input circuit 602 can be configured to receive a plurality of first data elements (e.g., W). In some embodiments, the input circuit 602 can a data latch, which facilitates weight reuse. The input circuit 602 may have a data input (e.g., W) and a clock input (e.g., CLK). In some embodiments, the input circuit 602 captures the value on the data input at a specific part of the clock cycle and holds this value until the next clock pulse. In some embodiments, the first data elements may include a plurality of weight data elements. In certain embodiments, the first data elements may include a plurality of input data elements.

In some embodiments, the memory array 604 can be coupled to the input circuit 602. The memory array 204 can be configured to store the plurality of first data elements. In some embodiments, the memory array 604 may include a plurality of memory cells. Each of the plurality of memory cells can incorporate various types of non-volatile or volatile memory technologies, including but not limited to static random-access memory (SRAM), dynamic random access memory (DRAM), resistive random-access memory (ReRAM), magnetoresistive random-access memory (MRAM), and phase-change random access memory (PCRAM). One or more peripheral circuits (not shown) may be located at one or more regions peripheral to, or within, the memory array 604. The memory cells and the periphery circuits may be coupled by word lines and/or complementary bit lines BL and BLB, and data can read from and written to the memory bit cells via the complementary bit lines BL and BLB. Different voltage combinations applied to the word lines and bit lines may define a read, erase or write (program) operation on the memory bit cells.

In some embodiments, each of the plurality of CIM circuits 110 can be coupled to the memory array 604 with a first data path. In some embodiments, each of the plurality of CIM circuits 110 can be coupled to the input circuit 602 with a second data path. In some embodiments, the first data path may operatively extend from an input circuit 602, through a memory array 604 and a data multiplexer 112, and to a plurality of computing cells 114. In some embodiments, the second data path may operatively extend from an input circuit 602, through a data multiplexer 112, and to a plurality of computing cells 114.

In some embodiments, each of the plurality of CIM circuits 110 may comprise a data multiplexer 112 and a plurality of computing cells 114. Each of the plurality of CIM circuits 110 may receive an enable signal. The data multiplexer 112 can be configured to output a plurality of first data elements through a first data path or through a second data path according to the enable signal (e.g., 1 or 0). In FIG. 6, in response to the enable signal being configured with a first logic state (e.g., 1, encoder mode), the data multiplexer 112 may select the first data path. In FIG. 7, in response to the enable signal being configured with a second logic state (e.g., 0, decoder mode), the data multiplexer 112 may select the second data path.

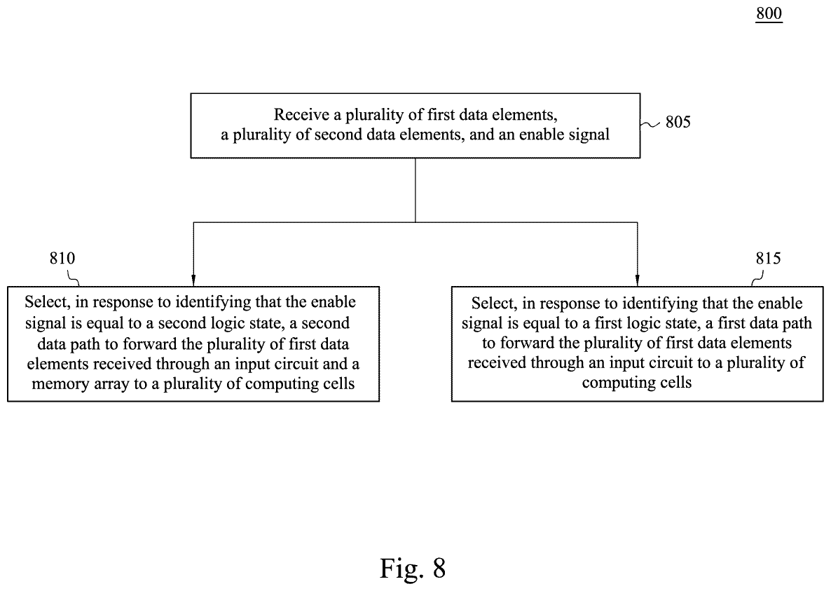

FIG. 8 is a flowchart of an example method for operating a compute-in-memory (CIM) circuit, in accordance with some embodiments of the present disclosure. It is understood that FIG. 8 has been simplified for a better understanding of the concepts of the present disclosure. Accordingly, it should be noted that additional processes may be provided before, during, and after the method of FIG. 8, and that some other processes may only be briefly described herein.

Referring to operation 805, and in some embodiments, a compute-in-memory (CIM) circuit 110 can be configured to receive a plurality of first data elements (e.g., W), a plurality of second data elements (e.g., Xin), and an enable signal (e.g., EN). In some embodiments, the data multiplexer 112 of the CIM circuit 110 may receive an enable signal. The data multiplexer 112 can be configured to output a plurality of first data elements through a first data path or through a second data path according to the enable signal. In some embodiments, the plurality of computing cells 114 can be coupled to the data multiplexer 112. In some embodiments, the plurality of computing cells 114 can be configured to receive multiple inputs (e.g., first data elements, second data elements). The plurality of computing cells 114 can be configured to perform multiply-accumulate (MAC) operations on the plurality of first data elements and a plurality of second data elements. In some embodiments, the first data elements may include a plurality of weight data elements. The second data elements may include a plurality of input data elements. In certain embodiments, the first data elements may include a plurality of input data elements. The second data elements may include a plurality of weight data elements.

Next, the method 800 proceeds to operation 810 of selecting, in response to identifying that the enable signal is equal to a first logic state, a first data path to forward the plurality of first data elements received through an input circuit and a memory array to a plurality of computing cells. The plurality of computing cells can be configured to perform multiply-accumulate (MAC) operations on the plurality of first data elements and a plurality of second data elements. In some embodiments, by processing through the first data path, the CIM circuit 110 can function as an encoder (e.g., encoder mode). The encoder may include a multi-head attention component and a feed forward neural network component. The multi-head attention component is configured to perform self-attention processes in parallel using different weight matrices, allowing the model to capture various types of relationships in the data simultaneously. The feed forward neural network component is configured to further refine the attention-processed output. Each position in the input sequence undergoes the same neural network process independently. There is no need for masking in the self-attention layers of the encoder because all inputs are available at the time of processing.

Next, the method 800 proceeds to operation 815 of selecting, in response to identifying that the enable signal is equal to a second logic state, a second data path to forward the plurality of first data element received through the input circuit to the plurality of computing cells. In some embodiments, by processing through the second data path, the CIM circuit 110 can function as a decoder (e.g., decoder mode). The decoder may include a masked multi-head attention component, a multi-head attention component, and a feed forward network component. The masked multi-head attention component can be configured to selectively prevent certain positions in an input sequence from influencing output positions during attention calculations. The multi-head attention component can be configured to process multiple attention mechanisms in parallel, each applying attention to different representation subspaces of the input sequence. The feed forward network component can be structured to apply the same neural network configuration across all positions in a sequence independently. Both the encoder and decoder layers use layer normalization and residual connections around each sub-layer (self-attention, feed-forward networks, and in the decoder, encoder-decoder attention) to facilitate training and improve the flow of gradients through the network.

The present application provides a CIM-based accelerator incorporates advanced features to enhance its versatility and efficiency in processing. The present application enables the encoder CIM to support decoder functions, achieving this flexibility with negligible area overhead, which is for maintaining compact and efficient circuit design. The present application introduces a data multiplexer (MUX) within the integrated circuit. This MUX is strategically placed to select between data sourced directly from the memory or from a data latch, effectively allowing the option to bypass the memory when necessary. This capability is particularly beneficial in scenarios where speed and response time are prioritized over memory reads. The present application supports all types of memory technologies including DRAM, ReRAM, and MRAM, across various technology nodes. This universal compatibility ensures that the accelerator can be integrated into diverse system environments and optimized for a wide range of applications, from mobile devices to large-scale data centers, providing a robust solution adaptable to future technological advancements.

In one aspect of the present disclosure, an integrated circuit is disclosed. The integrated circuit may comprise a plurality of compute-in-memory (CIM) circuits physically formed on a substrate. Each of the plurality of CIM circuits may comprise: an input circuit configured to receive a plurality of first data elements; a memory array coupled to the input circuit and configured to store the plurality of first data elements; a data multiplexer configured to output the plurality of first data elements through a first data path or through a second data path; and a plurality of computing cells coupled to the data multiplexer and configured to perform multiply-accumulate (MAC) operations on the plurality of first data elements and a plurality of second data elements.

In another aspect of the present disclosure, an integrated circuit is disclosed. The integrated circuit may comprise a plurality of compute-in-memory (CIM) circuits. Each of the plurality of CIM circuits can be configured to output a respective plurality of multiply-accumulate (MAC) results. Each of the plurality of CIM circuits may at least comprise a data multiplexer and a plurality of computing cells. The data multiplexer can be configured to: forward a plurality of first data elements through a first data path, in response to receiving an enable signal configured with a first logic state; or forward the plurality of first data elements through a second data path, in response to receiving the enable signal configured with a second logic state. The plurality of computing cells can be configured to receive a plurality of second data elements. The plurality of computing cells can be configured to output the respective MAC results based on the plurality of second data elements received and the plurality of first data elements forwarded by the data multiplexer.

In yet another aspect of the present disclosure, a method for operating an integrated circuit. The method may comprise receiving a plurality of first data elements, a plurality of second data elements, and an enable signal. The method may comprise selecting, in response to identifying that the enable signal is equal to a first logic state, a first data path to forward the plurality of first data elements received through an input circuit and a memory array to a plurality of computing cells. The plurality of computing cells can be configured to perform multiply-accumulate (MAC) operations on the plurality of first data elements and a plurality of second data elements. The method may comprise selecting, in response to identifying that the enable signal is equal to a second logic state, a second data path to forward the plurality of first data element received through the input circuit to the plurality of computing cells.

As used herein, the terms “about” and “approximately” generally indicates the value of a given quantity that can vary based on a particular technology node associated with the subject semiconductor device. Based on the particular technology node, the term “about” can indicate a value of a given quantity that varies within, for example, 10-30% of the value (e.g., +10%, ±20%, or ±30% of the value).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. An integrated circuit, comprising:
a plurality of compute-in-memory (CIM) circuits physically formed on a substrate;
wherein each of the plurality of CIM circuits comprises:
an input circuit configured to receive a plurality of first data elements;
a memory array coupled to the input circuit and configured to store the plurality of first data elements;
a data multiplexer configured to output the plurality of first data elements through a first data path or through a second data path; and
a plurality of computing cells coupled to the data multiplexer and configured to perform multiply-accumulate (MAC) operations on the plurality of first data elements and a plurality of second data elements.

2. The integrated circuit of claim 1, wherein the memory array includes a plurality of memory cells, each of which includes a static random access memory (SRAM) cell, a dynamic random access memory (DRAM) cell, a resistive random access memory (RRAM), or a magnetoresistive random access memory (MRAM) cell.

3. The integrated circuit of claim 1, wherein the data multiplexer is configured to:
receive an enable signal;
in response to the enable signal being configured with a first logic state, select the first data path; and
in response to the enable signal being configured with a second logic state, select the second data path.

4. The integrated circuit of claim 3, wherein
the first data path operatively extends from the input circuit, through the memory array and the data multiplexer, and to the plurality of computing cells; and
the second data path operatively extends from the input circuit, through the data multiplexer, and to the plurality of computing cells.

5. The integrated circuit of claim 3, wherein the enable signal is received by the plurality of CIM circuits.

6. The integrated circuit of claim 3, wherein a plural number of the enable signal are received by the plurality of CIM circuits, respectively.

7. The integrated circuit of claim 1, wherein the first data elements include a plurality of weight data elements, and the second data elements include a plurality of input data elements.

8. The integrated circuit of claim 1, wherein the first data elements include a plurality of input data elements, and the second data elements include a plurality of weight data elements.

9. An integrated circuit, comprising:
a plurality of compute-in-memory (CIM) circuits, each of the plurality of CIM circuits configured to output a respective plurality of multiply-accumulate (MAC) results;
wherein each of the plurality of CIM circuits at least comprises:
a data multiplexer configured to:
forward a plurality of first data elements through a first data path, in response to receiving an enable signal configured with a first logic state; or
forward the plurality of first data elements through a second data path, in response to receiving the enable signal configured with a second logic state; and
a plurality of computing cells configured to:
receive a plurality of second data elements; and
output the respective MAC results based on the plurality of second data elements received and the plurality of first data elements forwarded by the data multiplexer.

10. The integrated circuit of claim 9, wherein each of the plurality of CIM circuits further comprises:
an input circuit configured to receive the plurality of first data elements; and
a memory array coupled to the input circuit and configured to store the plurality of first data elements.

11. The integrated circuit of claim 9, further comprising:
an input circuit configured to receive the plurality of first data elements; and
a memory array coupled to the input circuit and configured to store the plurality of first data elements and to output the plurality of first data elements to the plurality of CIM circuits;
wherein each of the plurality of CIM circuits is configured to receive the plurality of first data elements through the first data path or through the second data path.

12. The integrated circuit of claim 10, wherein the memory array includes a plurality of memory cells, each of which includes a static random access memory (SRAM) cell, a dynamic random access memory (DRAM) cell, a resistive random access memory (RRAM), or a magnetoresistive random access memory (MRAM) cell.

13. The integrated circuit of claim 9, wherein
the first data path operatively extends from an input circuit, through a memory array and the data multiplexer, and to the plurality of computing cells; and
the second data path operatively extends from the input circuit, through the data multiplexer, and to the plurality of computing cells.

14. The integrated circuit of claim 9, wherein the enable signal is received by the plurality of CIM circuits.

15. The integrated circuit of claim 9, wherein a plural number of the enable signal are received by the plurality of CIM circuits, respectively.

16. The integrated circuit of claim 9, wherein the first data path comprises a multi-head attention component and a feed forward neural network component.

17. The integrated circuit of claim 9, wherein the second data path comprises a masked multi-head attention component, a multi-head attention component, and a feed forward network component.

18. A method, comprising:
receiving a plurality of first data elements, a plurality of second data elements, and an enable signal;
selecting, in response to identifying that the enable signal is equal to a first logic state, a first data path to forward the plurality of first data elements received through an input circuit and a memory array to a plurality of computing cells, wherein the plurality of computing cells are configured to perform multiply-accumulate (MAC) operations on the plurality of first data elements and a plurality of second data elements; and
selecting, in response to identifying that the enable signal is equal to a second logic state, a second data path to forward the plurality of first data element received through the input circuit to the plurality of computing cells.

19. The method of claim 18, wherein the first data elements include a plurality of weight data elements, and the second data elements include a plurality of input data elements.

20. The method of claim 18, wherein the first data elements include a plurality of input data elements, and the second data elements include a plurality of weight data elements.
